(19) United States
(12) Patent Application Publication
(10) Pub. No.: US 2021/0002315 A1
(43) Pub. Date: Jan. 7, 2021

(54) SILICON-TERMINATED ORGANO-METAL COMPOUNDS AND PROCESSES FOR PREPARING THE SAME

(71) Applicant: Dow Global Technologies LLC, Midland, MI (US)

(72) Inventors: Lixin Sun, Sugar Land, TX (US); Phillip D. Hustad, St. Paul, MN (US)

(21) Appl. No.: 16/982,520

(22) PCT Filed: Mar. 18, 2019
(86) PCT No.: PCT/US2019/022772

§ 371 Date: Sep. 18, 2020

Related U.S. Application Data
(60) Provisional application No. 62/644,664, filed on Mar. 19, 2018.

(51) Int. Cl. C07F 19/00; C08F 110/02

(52) U.S. Cl. CPC C07F 19/00; C08F 110/02

(57) ABSTRACT

The present disclosure is directed to a silicon-terminated organo-metal composition comprising a compound of formula (I). Embodiments relate to a process for preparing the silicon-terminated organo-metal composition comprising the compound of formula (I), the process comprising combining starting materials comprising (A) a vinyl-terminated silicon-based compound and (B) a chain shuttling agent, thereby obtaining a product comprising the silicon-terminated organo-metal composition. In further embodiments, the starting materials of the process may further comprise (C) a solvent.

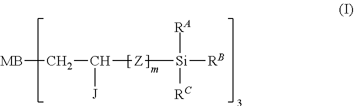

### CROSS-REFERENCE TO RELATED APPLICATIONS

The present application claims the benefit of priority to U.S. provisional patent application No. 62/644,664, filed on Mar. 19, 2018, which is hereby incorporated by reference in its entirety.

### FIELD

Embodiments relate to silicon-terminated organo-metal compositions and processes for preparing the same.

### BACKGROUND

In recent years, advances in polymer design have been seen with the use of compositions capable of chain shuttling and/or chain transfer. For example, chain shuttling agents having reversible or partial reversible chain transfer ability with transition metal catalysts have enabled the production of novel olefin block copolymers (OBCs). Typical compositions capable of chain shuttling and/or chain transfer are simple metal alkyls, such as diethyl zinc and triethyl aluminum. Upon polymerization of a chain shuttling agent, polymeryl-metal intermediates can be produced, including but not limited to compounds having the formula Q₂Zn or Q₃Al, with Q being an oligo- or polymeric substituent. These polymeryl-metal intermediates can enable the synthesis of novel end-functional polyolefins, including novel silicon-terminated organo-metal compositions.

### SUMMARY

In certain embodiments, the present disclosure relates to a silicon-terminated organo-metal composition comprising a compound of formula (I):

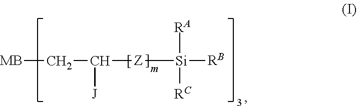

wherein:

MB is a trivalent metal selected from the group consisting of Al, B, and Ga;

each Z is independently a substituted or unsubstituted divalent C₁ to C₂₀ hydrocarbyl group that is linear, branched, or cyclic;
each subscript m is a number from 1 to 100,000;
each J is independently a hydrogen atom or a monovalent C₁ to C₂₀ hydrocarbyl group;
each R^{A}, R^{B}, and R^{C} is independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

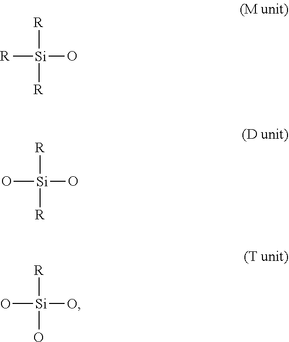

wherein each R is independently a hydrogen atom, a substituted or unsubstituted C₁ to C₁₀ monovalent hydrocarbyl group that is linear, branched, or cyclic, a vinyl group, or an alkoxy group;

two or all three of R^{A}, R^{B}, and R^{C} of one silicon atom may optionally be bonded together to form a ring structure when two or all three of R^{A}, R^{B}, and R^{C} of one silicon atom are each independently one or more siloxy units selected from D and T units.

In certain embodiments, the present disclosure relates to a process for preparing a silicon-terminated organo-metal composition comprising combining starting materials at an elevated temperature, wherein the starting materials comprise:
(A) a vinyl-terminated silicon-based compound; and
(B) a chain shuttling agent, thereby obtaining a product comprising the silicon-terminated organo-metal composition.

In certain embodiments, the starting materials of the process may further comprise optional materials, such as (C) a solvent.

### BRIEF DESCRIPTION OF DRAWINGS

FIG. 1 is the ¹H NMR spectra of Example 1.

FIG. 2 is the GCMS spectrum of Example 1.

FIG. 3 is the ¹³C NMR of Example 2.

FIG. 4 is the ¹H NMR spectrum of Example 2.

FIG. 5 is the GPC of Example 2.

### DETAILED DESCRIPTION

The present disclosure is directed to a process for preparing a silicon-terminated organo-metal composition, the process comprising 1) combining starting materials comprising (A) a vinyl-terminated silicon-based compound and (B) a chain shuttling agent. In further embodiments, the starting materials of the process may further comprise (C) a solvent and any other optional materials.

Step 1) of combining the starting materials may be performed by any suitable means, such as mixing at elevated temperatures. In certain embodiments, step 1) of combining the starting materials may be conducted at a temperature of from 50° C. to 200° C., or from 60° C. to 200° C., or from 80° C. to 180° C. or from 100° C. to 150° C., at ambient pressure. Heating may be performed under inert, dry conditions. In certain embodiments, step 1) of combining the starting materials may be performed for a duration of from 30 minutes to 20 hours, or from 30 minutes to 15 hours, or from 1 hour to 10 hours. In further embodiments, step 1) of combining the starting materials may be performed by solution processing (i.e., dissolving and/or dispersing the starting materials in a (C) solvent and heating) or melt extrusion (e.g., when a (C) solvent is not used or is removed during processing).

The process may optionally further comprise one or more additional steps. For example, the process may further comprise: 2) recovering the silicon-terminated telechelic polyolefin composition. Recovering may be performed by any suitable means, such as precipitation and filtration, thereby removing unwanted materials.

The amount of each starting material depends on various factors, including the specific selection of each starting material.

### (A) Vinyl-Terminated Silicon-Based Compound

Starting material (A) of the present process may be a vinyl-terminated silicon-based compound having the formula (II):

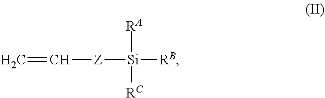

wherein:

Z is a substituted or unsubstituted divalent C₁ to C₂₀ hydrocarbyl group that is linear, branched, or cyclic;

R^{A}, R^{B}, and R^{C} are each independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

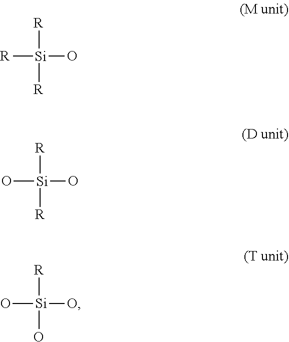

wherein each R is independently a hydrogen atom, a substituted or unsubstituted C₁ to C₁₀ monovalent hydrocarbyl group that is linear, branched, or cyclic, a vinyl group, or an alkoxy group; and two or all three of R^{A}, R^{B}, and R^{C} may optionally be bonded together to form a ring structure when two or all three of R^{A}, R^{B}, and R^{C} are each independently one or more siloxy units selected from D and T units.

In certain embodiments of the vinyl-terminated silicon-based compound having the formula (II), at least one of R^{A}, R^{B}, and R^{C} is a hydrogen atom or a vinyl group. In further embodiments, each of at least two of R^{A}, R^{B}, and R^{C} is a linear C₁ to C₁₀ monovalent hydrocarbyl group. In further embodiments, Z is an unsubstituted divalent C₁ to C₂₀ hydrocarbyl group that is linear or branched.

Suitable vinyl-terminated silicon-based compounds include but are not limited to 7-octenylsilane, 7-octenyldimethylvinylsilane, and the like.

### (B) Chain Shuttling Agent

Starting material (B) of the present process may be a chain shuttling agent having the formula Y₃MB, where MB may be a trivalent metal atom, and each X is independently a hydrocarbyl group of 1 to 20 carbon atoms. In certain embodiments, MB may be but is not limited to Al, B, or Ga. In further embodiments, MB may be Al. The monovalent hydrocarbyl group of 1 to 20 carbon atoms may be alkyl group exemplified by ethyl, propyl, octyl, and combinations thereof. Suitable chain shuttling agents include those disclosed in U.S. Pat. Nos. 7,858,706 and 8,053,529, which are hereby incorporated by reference.

Suitable chain shuttling agents include but are not limited to trimethyl aluminum, triethyl aluminum, tripropyl aluminum, tributyl aluminum, triisobutyl aluminum, trihexyl aluminum, triisohexyl aluminum, trioctyl aluminum, triisooctyl aluminum, tripentyl aluminum, tridecyl aluminum, tribranched alkyl aluminums, tricycloalkyl aluminums, triphenyl aluminum, tritolyl aluminum, dialkyl and aluminum hydrides.

### (C) Solvent

Starting material (C) of the present process may optionally be used in step 1) of the process described above. The solvent may be a hydrocarbon solvent such as an aromatic solvent or an isoparaffinic hydrocarbon solvent. Suitable solvents include but are not limited to a non-polar aliphatic or aromatic hydrocarbon solvent selected from the group of pentane, hexane, heptane, octane, nonane, decane, undecane, dodecane, cyclopentane, methylcyclopentane, cyclohexane, methylcyclohexane, cycloheptane, cyclooctane, decalin, benzene, toluene, xylene, an isoparaffinic fluid including but not limited to Isopar™ E, Isopar™ G, Isopar™ H, Isopar™ L, Isopar™ M, a dearomatized fluid including but not limited to Exxsol™ D or isomers and mixtures of two or more thereof. Alternatively, the solvent may be toluene and/or Isopar™ E. The amount of solvent added depends on various factors including the type of solvent selected and the process conditions and equipment that will be used.

### Product and Polymerization

The present process described herein results a silicon-terminated organo-metal composition comprising a compound of formula (I):

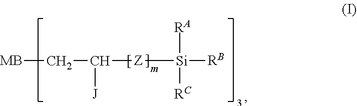

wherein:

MB is a trivalent metal selected from the group consisting of Al, B, and Ga;

each Z is independently a substituted or unsubstituted divalent C₁ to C₂₀ hydrocarbyl group that is linear, branched, or cyclic;
each subscript m is a number from 1 to 100,000;
each J is independently a hydrogen atom or a monovalent C₁ to C₂₀ hydrocarbyl group;
each R^{A}, R^{B}, and R^{C} is independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

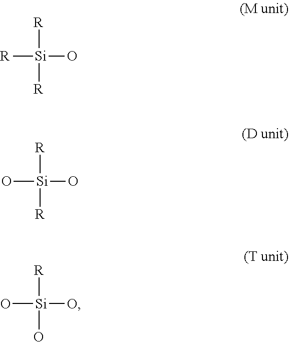

wherein each R is independently a hydrogen atom, a substituted or unsubstituted C₁ to C₁₀ monovalent hydrocarbyl group that is linear, branched, or cyclic, a vinyl group, or an alkoxy group;

two or all three of R^{A}, R^{B}, and R^{C} of one silicon atom may optionally be bonded together to form a ring structure when two or all three of R^{A}, R^{B}, and R^{C} of one silicon atom are each independently one or more siloxy units selected from D and T units.

In certain embodiments of formula (I), MB is Al. In certain embodiments, each subscript m is a number from 1 to 75,000, from 1 to 50,000, from 1 to 25,000, from 1 to 15,000, from 1 to 10,000, from 1 to 5,000, from 1 to 2,500, or from 1 to 1,000. In certain embodiments, each J is a hydrogen atom. In certain embodiments, each Z is an unsubstituted C₁ to C₁₀ divalent hydrocarbyl group that is linear.

In certain embodiments, at least one of R^{A}, R^{B}, and R^{C} of each silicon atom may be a hydrogen atom or a vinyl group. In further embodiments, each of at least two of R^{A}, R^{B},and R^{C} of each silicon atom may be a linear C₁ to C₁₀ monovalent hydrocarbyl group. In further embodiments, each of at least two of R^{A}, R^{B}, and R^{C} of each silicon atom may be a methyl group.

Examples of the —SiR^{A}R^{B}R^{C} groups of the compounds of formulas (I) and (II) include but are not limited to the following, where the squiggly line [symbol] denotes the attachment of the group to the Z group of the compounds of formulas (I) and (II).

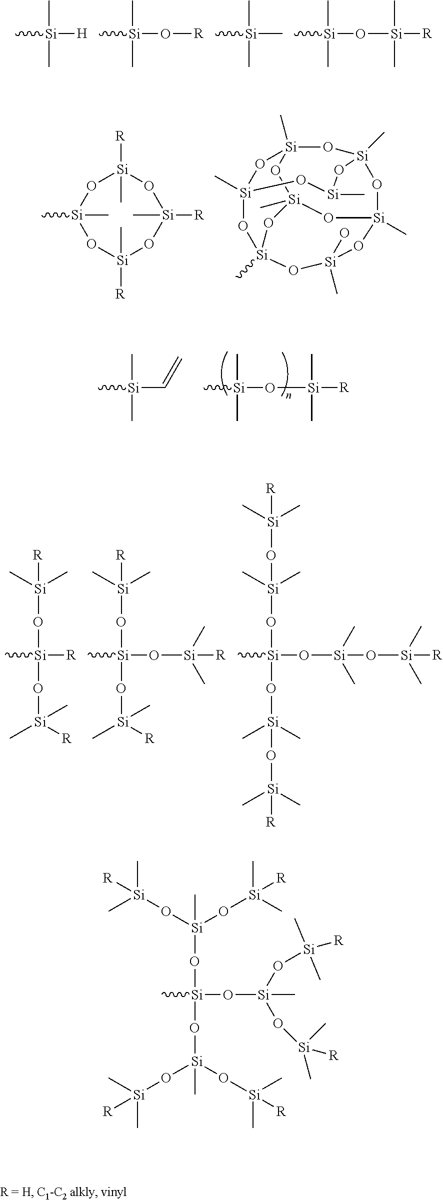

In further embodiments, the process for preparing the silicon-terminated organo-metal composition of the present disclosure may be followed by a subsequent polymerization step to form a silicon terminated polymeryl-metal, which still falls under the definition of the silicon-terminated organo-metal composition of the present disclosure. Specifically, the silicon-terminated organo-metal of the present disclosure may be combined with a procatalyst, an activator, at least one olefin monomer, and optional materials, such as solvents and/or scavengers. Such a polymerization step will be performed under polymerization process conditions known in the art, including but not limited to those disclosed in U.S. Pat. Nos. 7,858,706 and 8,053,529. Such a polymerization step essentially increases the subscript m in the formula (I).

The procatalyst may be any compound or combination of compounds capable of, when combined with an activator, polymerization of unsaturated monomers. Suitable procatalysts include but are not limited to those disclosed in WO 2005/090426, WO 2005/090427, WO 2007/035485, WO 2009/012215, WO 2014/105411, WO 2017/173080, U.S. Patent Publication Nos. 2006/0199930, 2007/0167578, 2008/0311812, and U.S. Pat. Nos. 7,355,089 B2, 8,058,373 B2, and 8,785,554 B2.

Suitable procatalysts include but are not limited to the following structures labeled as procatalysts (A1) to (A8):

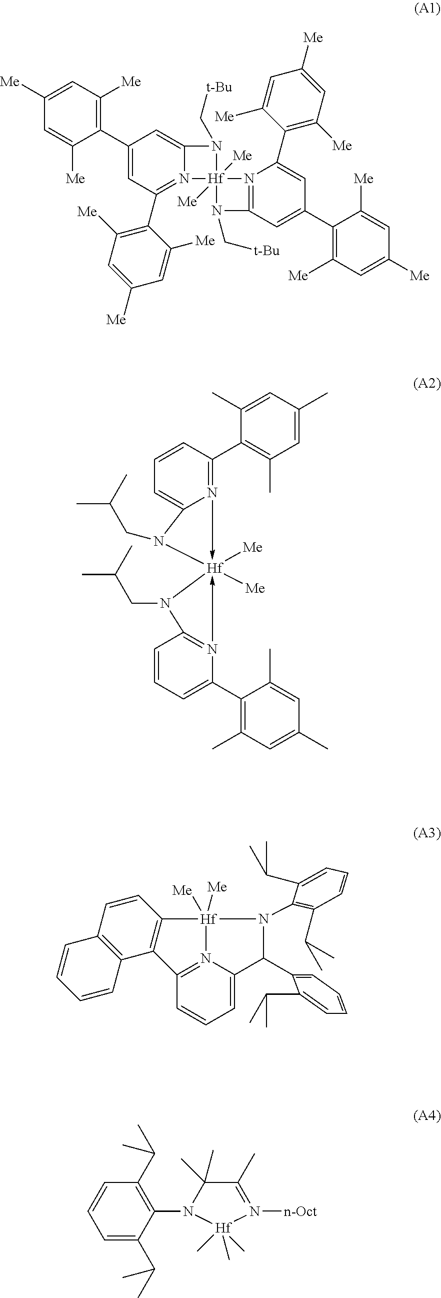

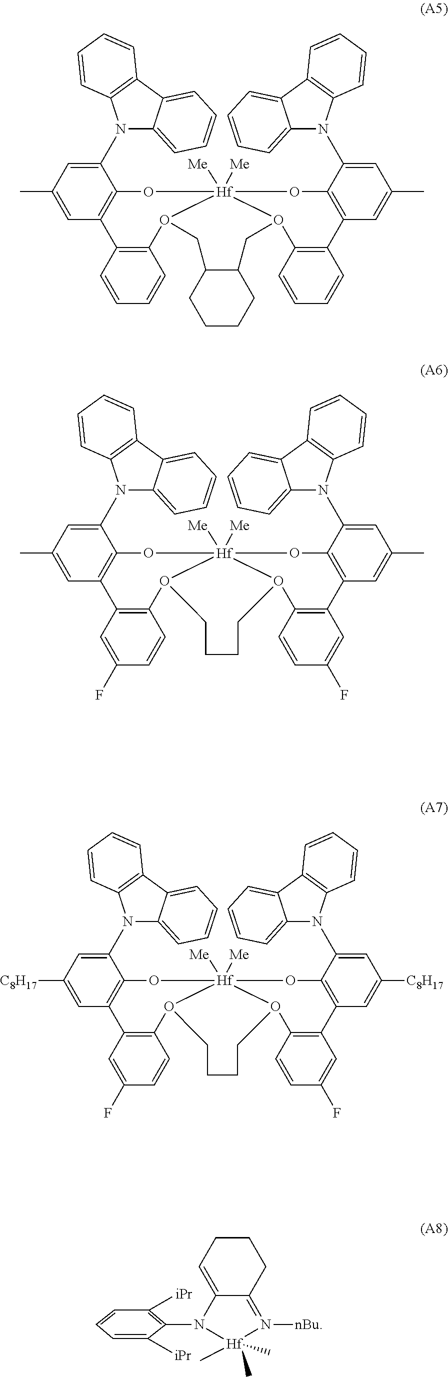

Procatalysts (A1) and (A2) may be prepared according to the teachings of WO 2017/173080 A1 or by methods known in the art. Procatalyst (A3) may be prepared according to the teachings of WO 03/40195 and U.S. Pat. No. 6,953,764 B2 or by methods known in the art. Procatalyst (A4) may be prepared according to the teachings of Macromolecules (Washington, DC, United States), 43(19), 7903-7904 (2010) or by methods known in the art. Procatalysts (A5), (A6), and (A7) may be prepared according to the teachings of WO 2018/170138 A1 or by methods known in the art. Procatalyst (A8) may be prepared according to the teachings of WO 2011/102989 A1 or by methods known in the art.

The activator may be any compound or combination of compounds capable of activating a procatalyst to form an active catalyst composition or system. Suitable activators include but are not limited to Brønsted acids, Lewis acids, carbocationic species, or any activator known in the art, including but limited to those disclosed in WO 2005/090427 and U.S. Pat. No. 8,501,885 B2. In exemplary embodiments of the present disclosure, the co-catalyst is [(C₁₆₋₁₈H₃₃₋₃₇)₂CH₃NH] tetrakis(pentafluorophenyl)borate salt.

Suitable monomers for the polymerization step include any addition polymerizable monomer, generally any olefin or diolefin monomer. Suitable monomers can be linear, branched, acyclic, cyclic, substituted, or unsubstituted. In one aspect, the olefin can be any α-olefin, including, for example, ethylene and at least one different copolymerizable comonomer, propylene and at least one different copolymerizable comonomer having from 4 to 20 carbons, or 4-methyl-1-pentene and at least one different copolymerizable comonomer having from 4 to 20 carbons. Examples of suitable monomers include, but are not limited to, straight-chain or branched α-olefins having from 2 to 30 carbon atoms, from 2 to 20 carbon atoms, or from 2 to 12 carbon atoms. Specific examples of suitable monomers include, but are not limited to, ethylene, propylene, 1-butene, 1-pentene, 3-methyl-1-butene, 1-hexane, 4-methyl-1-pentene, 3-methyl-1-pentene, 1-octene, 1-decene, 1-dodecene, 1-tetradecene, 1-hexadecene, 1-octadecene, and 1-eicosene. Suitable monomers also include cycloolefins having from 3 to 30, from 3 to 20 carbon atoms, or from 3 to 12 carbon atoms. Examples of cycloolefins that can be used include, but are not limited to, cyclopentene, cycloheptene, norbornene, 5-methyl-2-norbomene, tetracyclododecene, and 2-methyl-1,4,5,8-dimethano-1,2,3,4,4a,5,8,8a-octahydronaphthalene. Suitable monomers also include di- and poly-olefins having from 3 to 30, from 3 to 20 carbon atoms, or from 3 to 12 carbon atoms. Examples of di- and poly-olefins that can be used include, but are not limited to, butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidene norbornene, vinyl norbornene, dicyclopentadiene, 7-methyl-1,6-octadiene, 4-ethylidene-8-methyl-1,7-nonadiene, and 5,9-dimethyl-1,4,8-decatriene. In a further aspect, aromatic vinyl compounds also constitute suitable monomers for preparing the copolymers disclosed here, examples of which include, but are not limited to, mono- or poly-alkylstyrenes (including styrene, o-methylstyrene, m-methylstyrene, p-methylstyrene, o,p-dimethylstyrene, o-ethylstyrene, m-ethylstyrene and p-ethylstyrene), and functional group-containing derivatives, such as methoxystyrene, ethoxystyrene, vinylbenzoic acid, methyl vinylbenzoate, vinylbenzyl acetate, hydroxystyrene, o-chlorostyrene, p-chlorostyrene, divinylbenzene, 3-phenylpropene, 4-phenylpropene and α-methylstyrene, vinylchloride, 1,2-difluoroethylene, 1,2-dichloroethylene, tetrafluoroethylene, and 3,3,3-trifluoro-1-propene, provided the monomer is polymerizable under the conditions employed.

Silicon-terminated organo-metals prepared as described above followed by a polymerization step include but are not limited to silicon-terminated-tri-polyethylene aluminum, silicon-terminated-tri-poly(ethylene/octene) aluminum, and mixtures thereof.

Any subsequent polymerization step to prepare the silicon-terminated organo-metal composition of the present disclosure may be followed by hydrolysis or use of alcohol to remove the metal resulting in a silicon-terminated polymer.

The silicon-terminated organo-metal composition may include any or all embodiments disclosed herein.

### INDUSTRIAL APPLICABILITY

The present disclosure and below examples show inventive processes for preparing inventive silicon-terminated organo-metal compositions. These inventive silicon-terminated organo-metal compositions may be used in a variety of commercial applications, including facilitation of further functionalization or preparation of subsequent polymers, such as telechelic polymers.

### Definitions

All references to the Periodic Table of the Elements refer to the Periodic Table of the Elements published and copyrighted by CRC Press, Inc., 1990. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight and all test methods are current as of the filing date of this disclosure. For purposes of United States patent practice, the contents of any referenced patent, patent application or publication are incorporated by reference in their entirety (or its equivalent U.S. version is so incorporated by reference in its entirety), especially with respect to the disclosure of synthetic techniques, product and processing designs, polymers, catalysts, definitions (to the extent not inconsistent with any definitions specifically provided in this disclosure), and general knowledge in the art.

Number ranges in this disclosure are approximate and, thus, may include values outside of the ranges unless otherwise indicated. Number ranges include all values from and including the lower and the upper values, including fractional numbers or decimals. The disclosure of ranges includes the range itself and also anything subsumed therein, as well as endpoints. For example, disclosure of a range of 1 to 20 includes not only the range of 1 to 20 including endpoints, but also 1, 2, 3, 4, 6, 10, and 20 individually, as well as any other number subsumed in the range. Furthermore, disclosure of a range of, for example, 1 to 20 includes the subsets of, for example, 1 to 3, 2 to 6, 10 to 20, and 2 to 10, as well as any other subset subsumed in the range.

Similarly, the disclosure of Markush groups includes the entire group and also any individual members and subgroups subsumed therein. For example, disclosure of the Markush group a hydrogen atom, an alkyl group, an alkenyl group, or an aryl group, includes the member alkyl individually; the subgroup hydrogen, alkyl and aryl; the subgroup hydrogen and alkyl; and any other individual member and subgroup subsumed therein.

In the event the name of a compound herein does not conform to the structural representation thereof, the structural representation shall control.

The term “comprising” and derivatives thereof means including and is not intended to exclude the presence of any additional component, starting material, step or procedure, whether or not the same is disclosed therein.

The terms “group,” “radical,” and “substituent” are also used interchangeably in this disclosure.

The term “hydrocarbyl” means groups containing only hydrogen and carbon atoms, where the groups may be linear, branched, or cyclic, and, when cyclic, aromatic or non-aromatic.

The term “substituted” means that a hydrogen group has been replaced with a hydrocarbyl group, a heteroatom, or a heteroatom containing group. For example, methyl cyclopentadiene (Cp) is a Cp group substituted with a methyl group and ethyl alcohol is an ethyl group substituted with an —OH group.

“Catalyst precursors” include those known in the art and those disclosed in WO 2005/090426, WO 2005/090427, WO 2007/035485, WO 2009/012215, WO 2014/105411, U.S. Patent Publication Nos. 2006/0199930, 2007/0167578, 2008/0311812, and U.S. Pat. Nos. 7,355,089 B2, 8,058,373 B2, and 8,785,554 B2, all of which are incorporated herein by reference in their entirety. The terms “transition metal catalysts,” “transition metal catalyst precursors,” “catalysts,” “catalyst precursors,” “polymerization catalysts or catalyst precursors,” “procatalysts,” “metal complexes,” “complexes,” “metal-ligand complexes,” and like terms are to be interchangeable in the present disclosure.

“Co-catalyst” refers to those known in the art, e.g., those disclosed in WO 2005/090427 and U.S. Pat. No. 8,501,885 B2, that can activate the catalyst precursor to form an active catalyst composition. “Activator” and like terms are used interchangeably with “co-catalyst.”

The term “catalyst system,” “active catalyst,” “activated catalyst,” “active catalyst composition,” “olefin polymerization catalyst,” and like terms are interchangeable and refer to a catalyst precursor/co-catalyst pair. Such terms can also include more than one catalyst precursor and/or more than one activator and optionally a co-activator. Likewise, these terms can also include more than one activated catalyst and one or more activator or other charge-balancing moiety, and optionally a co-activator.

The terms “polymer,” “polymer,” and the like refer to a compound prepared by polymerizing monomers, whether of the same or a different type. The generic term polymer thus embraces the term homopolymer, usually employed to refer to polymers prepared from only one type of monomer, and the term interpolymer as defined below. It also embraces all forms of interpolymers, e.g., random, block, homogeneous, heterogeneous, etc.

“Interpolymer” and “copolymer” refer to a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

### EXAMPLES

### Methods

¹H NMR: ¹H NMR spectra are recorded on a Bruker AV-400 spectrometer at ambient temperature. ¹H NMR chemical shifts in benzene-d₆ are referenced to 7.16 ppm (C₆D₅H) relative to TMS (0.00 ppm).

¹³C NMR: ¹³C NMR spectra of polymers are collected using a Bruker 400 MHz spectrometer equipped with a Bruker Dual DUL high-temperature CryoProbe. The polymer samples are prepared by adding approximately 2.6 g of a 50/50 mixture of tetrachloroethane-d₂/orthodichlorobenzene containing 0.025 M chromium trisacetylacetonate (relaxation agent) to 0.2 g of polymer in a 10 mm NMR tube. The samples are dissolved and homogenized by heating the tube and its contents to 150° C. The data is acquired using 320 scans per data file, with a 7.3 second pulse repetition delay with a sample temperature of 120° C.

GC/MS: Tandem gas chromatography/low resolution mass spectroscopy using electron impact ionization (EI) is performed at 70 eV on an Agilent Technologies 6890N series gas chromatograph equipped with an Agilent Technologies 5975 inert XL mass selective detector and an Agilent Technologies Capillary column (HP1MS, 15 m×0.25 mm, 0.25 micron) with respect to the following:

### Programmed Method:

### Oven Equilibration Time 0.5 min

### 50° C. for 0 min

then 25° C./min to 200° C. for 5 min

### Run Time 11 min

GPC: The gel permeation chromatographic system consists of either a Polymer Laboratories Model PL-210 or a Polymer Laboratories Model PL-220 instrument. The column and carousel compartments are operated at 140° C. Three Polymer (Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume used is 100 microliters and the flow rate is 1.0 ml/minute.

Calibration of the GPC column set is performed with 21 narrow molecular weight distribution polystyrene standards with molecular weights ranging from 580 to 8,400,000, arranged in 6 “cocktail” mixtures with at least a decade of separation between individual molecular weights. The standards are purchased from Polymer Laboratories (Shropshire, UK). The polystyrene standards are prepared at 0.025 grams in 50 milliliters of solvent for molecular weights equal to or greater than 1,000,000 and 0.05 grams in 50 milliliters of solvent for molecular weights less than 1,000,000. The polystyrene standards are dissolved at 80° C. with gentle agitation for 30 minutes. The narrow standards mixtures are run first and in order of decreasing highest molecular weight component to minimize degradation. The polystyrene standard peak molecular weights are converted to polyethylene molecular weights using the following equation (as described in Williams and Ward, J. Polym. Sci., Polym. Let., 6, 621 (1968)): M_{polyethylene}=0.431(M_{polystyrene}). Polyethylene equivalent molecular weight calculations are performed using Viscotek TriSEC software Version 3.0.

Molecular Weight: Molecular weights are determined by optical analysis techniques including deconvoluted gel permeation chromatography coupled with a low angle laser light scattering detector (GPC-LALLS) as described by Rudin, A., “Modern Methods of Polymer Characterization”, John Wiley & Sons, New York (1991) pp. 103-112.

Unless noted otherwise, all starting materials for the examples described below are commercially available from, for example, Sigma-Aldrich and Gelest.

### Example 1

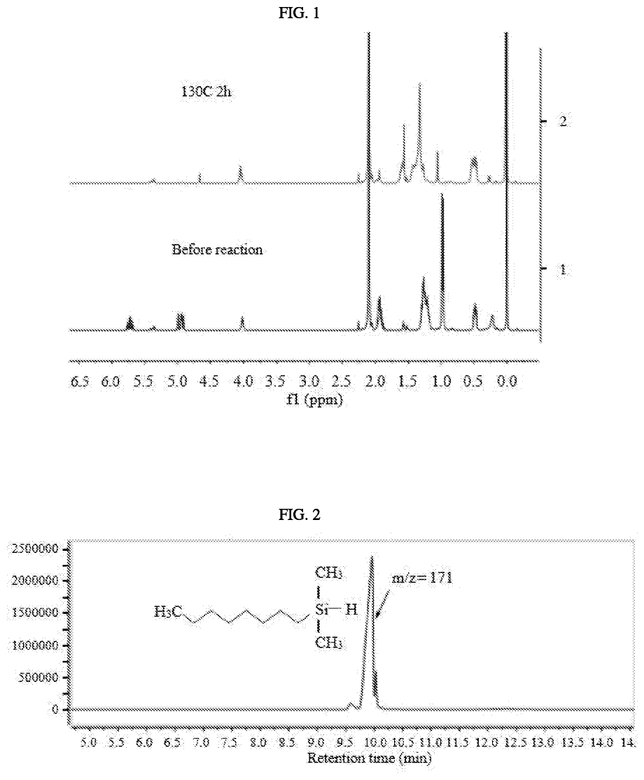

Synthesis of tris(8-dimethylsilyloctyl)aluminum. An exemplary silicon-terminated organo-metal composition is prepared as follows and as seen in Reaction Scheme 1. In a nitrogen-filled drybox, 7-octenyldimethylsilane (4.05 g, 23.78 mmol) and triisobutylaluminum (2.0 mL, 7.9 mmol) are mixed in 10 mL of p-xylene in a 40 mL glass vial with a stirbar and a venting needle on the cap. The mixture is heated to and held at 130° C. for 2 h with stirring. After 2 h, NMR (FIG. 1) shows that all vinyl groups disappeared. GCMS analysis (FIG. 2) of a hydrolyzed sample shows a major peak at m/z of 171, which is consistent to the expected reaction product.

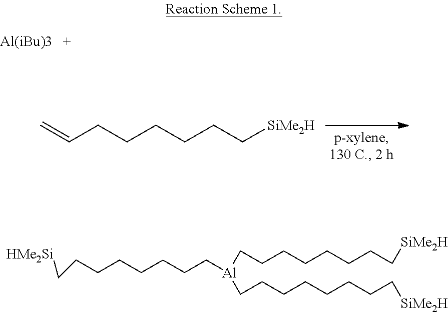

### Example 2—Ethylene Polymerization

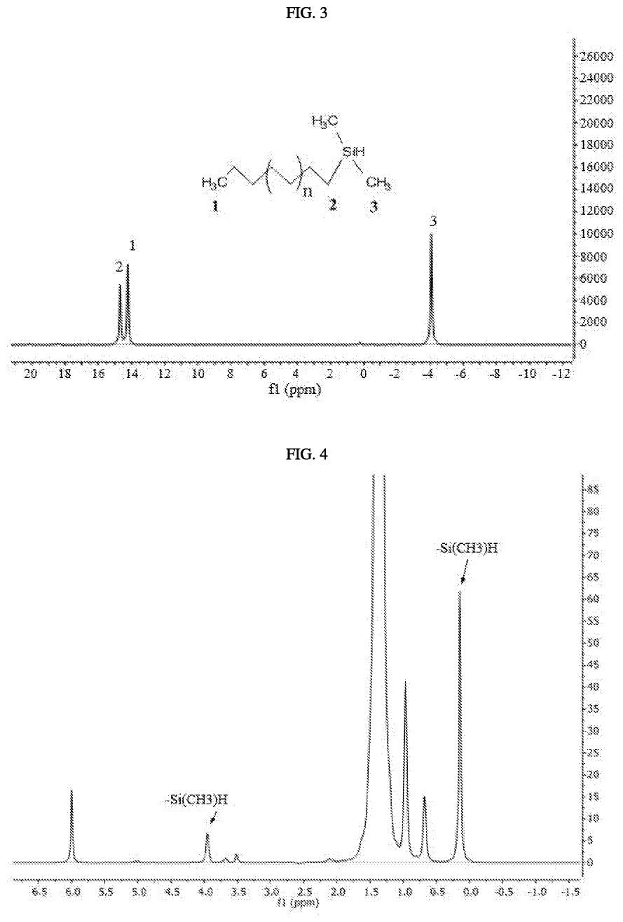

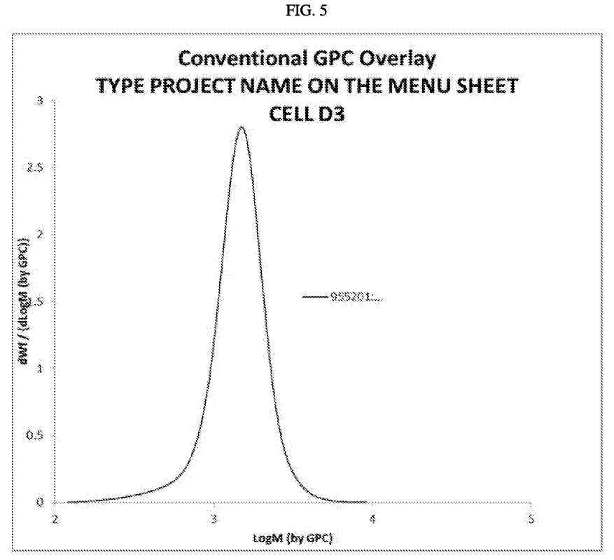

Subsequent ethylene polymerization of the silicon-terminated organo-metal prepared in Example 1 is performed as follows and as seen in Reaction Scheme 2. In a nitrogen-filled drybox, a 40 mL vial equipped with a stirbar was charged with Isopar E (10 mL) and the activator [(C₁₆₋₁₈H₃₃₋₃₇)₂CH₃NH] tetrakis(pentafluorophenyl)borate salt available from Boulder Scientific (Act. A in Reaction Scheme 2) (0.063 mL of 0.064 M solution in MCH, 0.004 mmol). The vial is sealed with a septum cap and placed in a heating block set to 100° C. The ethylene line (from a small cylinder) is connected and the vial headspace is slowly purged via a needle. Solutions of the silicon-terminated organo-metal of Example 1 (0.4 mL, 0.20 mmol) and Procatalyst (A4) (0.002 mmol) as defined above and labeled as PCA in Reaction Scheme 2 are injected and the purge needle is removed to maintain a total pressure at 12 psig. The reaction mixture is stirred for 30 min, then taken out of the drybox and quenched with MeOH (100 mL). The precipitated white polymer is stirred in methanol for 3 hours, followed by filtration and drying of the polymer under vacuum overnight. 0.73 g white polymer is collected. ¹³C NMR (FIG. 3) and ¹H NMR (FIG. 4) confirmed the polymer structure with terminal SiMe2H group. GPC results: Mₙ=1,273, M_{w}=1,534, PDI=1.21. The GPC chromatogram is shown in FIG. 5.

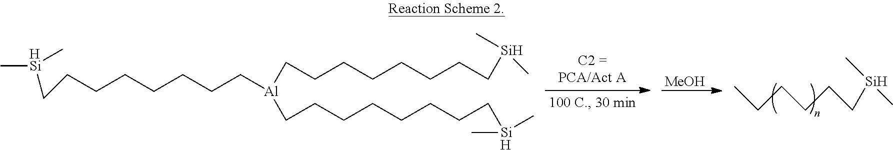

What is claimed is:

1. A silicon-terminated organo-metal composition comprising a compound of formula (I): 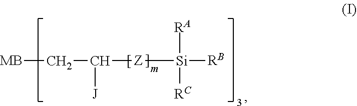
wherein:
MB is a trivalent metal selected from the group consisting of Al, B, and Ga;
each Z is independently a substituted or unsubstituted divalent C₁ to C₂₀ hydrocarbyl group that is linear, branched, or cyclic;
each subscript m is a number from 1 to 100,000;
each J is independently a hydrogen atom or a monovalent C₁ to C₂₀ hydrocarbyl group;
each R^{A}, R^{B}, and R^{C} is independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units: 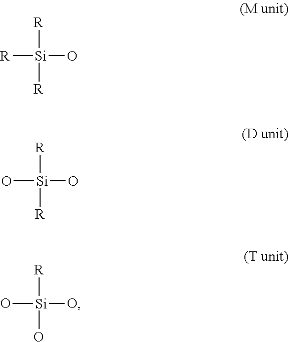
wherein each R is independently a hydrogen atom, a substituted or unsubstituted C₁ to C₁₀ monovalent hydrocarbyl group that is linear, branched, or cyclic, a vinyl group, or an alkoxy group;
two or all three of R^{A}, R^{B}, and R^{C} of a silicon atom may optionally be bonded together to form a ring structure when two or all three of R^{A}, R^{B}, and R^{C} of the silicon atom are each independently one or more siloxy units selected from D and T units.

2. The composition of claim 1, wherein MB is Al.

3. The composition of claim 1, wherein each J is a hydrogen atom.

4. The composition of claim 1, wherein each Z is an unsubstituted divalent C₁ to C₁₀ hydrocarbyl group that is linear.

5. The composition of claim 1, wherein each subscript m is a number from 1 to 1,000.

6. The composition of claim 1, wherein at least one of R^{A}, R^{B}, and R^{C} of each silicon atom is a hydrogen atom or a vinyl group.

7. The composition of claim 1, wherein each of at least two of R^{A}, R^{B}, and R^{C} of each silicon atom is a linear C₁ to C₁₀ monovalent hydrocarbyl group.

8. The composition of claim 1, wherein each of at least two of R^{A}, R^{B}, and R^{C} of each silicon atom is a methyl group.

9. A process for preparing a silicon-terminated organo-metal composition, the process comprising 1) combining starting materials comprising (A) a vinyl-terminated silicon-based compound and a (B) chain shuttling agent, thereby obtaining a product comprising the silicon-terminated organo-metal composition.

10. The process of claim 9, wherein the starting materials further comprise (C) a solvent.

11. The process of claim 9, wherein the (A) vinyl-terminated silicon-based compound has the formula (II): 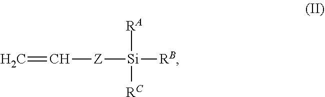
wherein:
Z is a substituted or unsubstituted divalent C₁ to C₂₀ hydrocarbyl group that is linear, branched, or cyclic;
R^{A}, R^{B}, and R^{C} are each independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units: 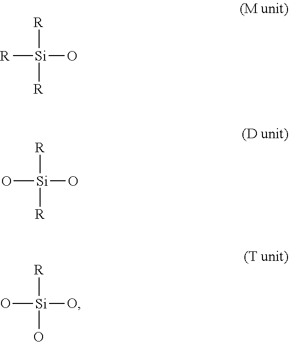
wherein each R is independently a hydrogen atom, a substituted or unsubstituted C₁ to C₁₀ monovalent hydrocarbyl group that is linear, branched, or cyclic, a vinyl group, or an alkoxy group; and
two or all three of R^{A}, R^{B}, and R^{C} may optionally be bonded together to form a ring structure when two or all three of R^{A}, R^{B}, and R^{C} are each independently one or more siloxy units selected from D and T units.

12. The process of claim 11, wherein at least one of R^{A}, R^{B}, and R^{C} is a hydrogen atom or a vinyl group.

13. The process of claim 11, wherein each of at least two of R^{A}, R^{B}, and R^{C} is a linear C₁ to C₁₀ monovalent hydrocarbyl group.

14. The process of claim 13, wherein each of at least two of R^{A}, R^{B}, and R^{C} is a methyl group.

15. The process of claim 11, wherein Z is an unsubstituted divalent C₁ to C₁₀ hydrocarbyl group that is linear.

16. The process of claim 9, wherein the vinyl-terminated silicon-based compound is selected from the group consisting of 7-octenyldimethylsilane, 7-octenyldimethylvinylsilane, and mixtures thereof.

17. The process of claim 9, wherein the (B) chain shuttling agent has the formula Y₃MB, where MB is Al, and each Y is independently a hydrocarbyl group of 1 to 20 carbon atoms.

18. The process of claim 9, wherein step 1) is performed at a temperature from 100 to 150° C.

19. The process of claim 18, wherein step 1) is performed for a duration of 1 to 10 hours.

20. The process of claim 9, wherein the process, after step 1), further comprises forming a silicon-terminated polymeryl-metal by a process comprising combining starting materials comprising:
i) the silicon-terminated organo-metal composition of any of claims 1 to 8,
ii) a procatalyst,
iii) an activator,
iv) at least one olefin monomer, and
an optional solvent.
